(19) United States
(12) Patent Application Publication
(10) Pub. No.: US 2026/0360279 A1
(43) Pub. Date: Nov. 12, 2026

(54) INTELLIGENT CARE TRAINING SYSTEM AND METHOD

(71) Applicant: Industrial Technology Research Institute, Hsinchu (TW)

(72) Inventors: Cheng-Yen Tsai, Keelung City (TW); Ching-Chiu Liao, Hsinchu County (TW); Shi-Nun Leu, Hsinchu City (TW); Shih-Fang Yang Mao, Hsinchu County (TW)

(73) Assignee: Industrial Technology Research Institute, Hsinchu (TW)

(21) Appl. No.: 19/674,136

(22) Filed: May 12, 2026

Related U.S. Application Data
(60) Provisional application No. 63/804,355, filed on May 12, 2025.

(51) Int. Cl. G09B 23/30

(52) U.S. Cl. CPC G09B 23/30

(57) ABSTRACT

An intelligent care training system includes a mannequin body having a trunk, limbs, and a counterweight module for simulating a sense of weight. The mannequin body is provided with a sensing module for detecting posture and movements and generating sensing data. A processing unit is connected to the sensing module and determines an operation state according to the sensing data, and outputs a feedback signal through a feedback module. The processing unit compares the sensing data with predetermined conditions to determine whether a care operation satisfies a training requirement, wherein the care operation including turning over, patting the back, dressing and undressing, bed entry/exit and transfer training.

### CROSS-REFERENCE TO RELATED APPLICATION

This application claims the priority benefit of U.S. provisional application serial no. 63/804,355, filed on May 12, 2025, the entire content of which is incorporated herein by reference.

### BACKGROUND

### Technical Field

The present disclosure relates to intelligent care and training technology, and more particularly, relates to an intelligent care training system and an intelligent care training method.

### Description of Related Art

With the development of an aging society, the demand for medical care and long-term care is increasing, making the professional training of caregivers particularly important. In a general care training process, trainees typically use a mannequin to practice various basic care operations, such as assisting the care recipient in turning over, patting the back, or performing daily nursing actions such as dressing/undressing. These training activities are intended to enable trainees to become familiar with correct operating postures and procedures, so as to ensure that they can provide safe and appropriate care services when actually facing care recipients in the future.

In some traditional training methods, the training mannequins used are mostly static structures. When trainees perform operations, they often need to rely on observing instructors to visually observe the operations and provide verbal guidance. During the process of independent practice, it is difficult for trainees to promptly perceive and correct erroneous actions. Therefore, the industry continues to seek improvements in the assessment methods for care training.

### SUMMARY

According to one of the embodiments of the present disclosure, an intelligent care training system is provided. The intelligent care training system includes a mannequin body, a sensing module, a processing unit, and a feedback module. The mannequin body has a trunk and a plurality of limbs, and is provided with at least one counterweight module to simulate the weight sensation of a care recipient during care operations. At least one sensing module is disposed on the mannequin body, includes a first sensor disposed on the trunk for detecting a posture change of the trunk, and at least one second sensor respectively disposed on at least part of the plurality of limbs for detecting motion states of the at least part of the plurality of limbs, wherein the first sensor and the second sensor are configured to generate sensing data when a trainer performs a care operation on the mannequin body. The processing unit is electrically connected to the at least one sensing module, and is configured to determine an operation state of the care operation based on the sensing data. The feedback module is electrically connected to the processing unit, and is configured to output a feedback signal based on the operation state. Wherein the processing unit compares the sensing data with at least one predetermined operation condition to determine whether the care operation satisfies an expected training requirement, and when the care operation includes a turning-over operation, the processing unit determines, based on the posture changes of the trunk detected by the first sensor and the motion states of the at least part of the plurality of limbs detected by the second sensors, whether at least one of a hand-lifting state, a foot-lifting state, and a turning-over state of the turning-over operation satisfies the at least one predetermined operation condition.

According to one of the embodiments of the present disclosure, an intelligent care training method is provided, includes detecting a posture change of a trunk by a first sensor disposed on a mannequin body, and detecting motion states of the at least part of the plurality of limbs by at least one second sensor disposed on at least part of the plurality of limbs, so as to generate sensing data; receiving the sensing data by a processing unit; comparing the sensing data with at least one predetermined operation condition by the processing unit to determine whether a care operation satisfies an expected training requirement; and outputting a feedback signal by a feedback module based on a determination result; wherein when the care operation includes a turning-over operation, the processing unit determines, based on the posture change of the trunk and the motion states of the at least part of the plurality of limbs, whether at least one of a hand-lifting state, a foot-lifting state, and a turning-over state of the turning-over operation satisfies the at least one predetermined operation condition.

### BRIEF DESCRIPTION OF THE DRAWINGS

FIG. 1 is a block diagram of an intelligent care training system according to an embodiment of the present invention.

FIG. 2 is a schematic diagram illustrating a configuration of a mannequin body and counterweight modules thereof according to an embodiment of the present invention.

FIG. 3 is a flowchart of an intelligent care training method according to an embodiment of the present invention.

FIG. 4 is a schematic diagram illustrating a configuration of sensing elements corresponding to turning-over training according to an embodiment of the present invention.

FIG. 5 is a schematic diagram of a turning-over training process according to an embodiment of the present invention.

FIG. 6 is a schematic diagram illustrating a configuration of sensing elements corresponding to back-patting training according to an embodiment of the present invention.

FIG. 7 is a schematic diagram of palm shape recognition and pressure distribution for back-patting training according to an embodiment of the present invention.

FIG. 8 is a schematic diagram of a back-patting training process according to an embodiment of the present invention.

FIG. 9 is a schematic diagram illustrating a configuration of sensing elements corresponding to dressing/undressing training according to an embodiment of the present invention.

FIG. 10 is a schematic diagram illustrating a configuration of sensing elements corresponding to bed entry/exit and transfer training according to an embodiment of the present invention.

FIG. 11 is a schematic diagram of communication and operation modes of an intelligent care training system according to an embodiment of the present invention.

### DESCRIPTION OF THE EMBODIMENTS

The present invention relates to an intelligent care training system, and more particularly to an intelligent care training system centered on a mannequin body and combined with a counterweight structure, a plurality of sensing modules, a processing unit, a feedback module, a training data recording module, and an optional display and interaction device. Compared with conventional mannequin bodies that can only provide static practice, the present invention may perform motion state detection, correctness determination, error feedback, and result recording on a care operation, so that a user can not only operate the mannequin body but also obtain real-time and quantifiable training information.

The present invention may be applied to training in turning-over, back-patting, dressing/undressing, bed entry/exit, wheelchair transfer, positioning, and other care technologies. By decomposing care motions into measurable sub-steps and comparing sensing data with predetermined operating conditions, the present invention may improve the problem of conventional teaching being overly dependent on manual guidance and subjective assessment by instructors, and establish a digitized training record that is trackable, comparable, and preservable for a long term.

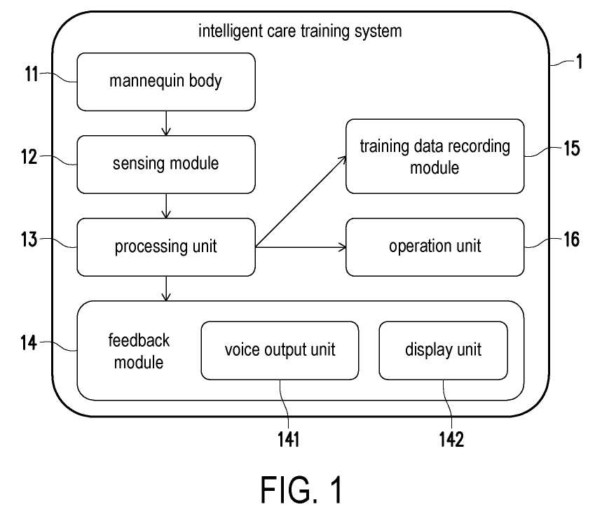

Please refer to FIG. 1, in an embodiment, the intelligent care training system 1 includes at least a mannequin body 11, a sensing module 12, a processing unit 13, and a feedback module 14, wherein the mannequin body 11 provides a carrier for care operations, the sensing module 12 is responsible for capturing physical values generated during the operation process, the processing unit 13 is responsible for determination and analysis, and the feedback module 14 converts the analysis results into prompt information understandable by the user, and presents training material process, the degree of completion, and assessment information.

The mannequin body 11 may be a care training mannequin, a realistic mannequin, or other human body model capable of simulating a care recipient, and includes a trunk and a plurality of limbs.

In an embodiment, the mannequin body 11 may be equipped with sensors and wires in a non-invasive, semi-invasive, or invasive manner depending on different training material scenarios. The non-invasive manner refers to, for example, disposing the sensing module on an external skin module, a clothing-type carrier, or an adhesive module; the semi-invasive manner refers to, for example, embedding partial sensing elements in a local cavity of the mannequin body; the invasive manner refers to integrating the sensing elements, wires, and partial counterweight modules into the interior of the mannequin body 11.

In an embodiment, the sensing module 12 may be disposed inside the mannequin body 11 to provide a more stable measurement position and a better integrated structure; in other embodiments, the sensing module 12 may also be externally disposed on the surface, back, chest, arm, foot, or other external carriers of the mannequin body 11 to provide higher replacement flexibility and convenience for training material expansion. Through flexible internal and external configurations, the intelligent care training system 1 may select the most suitable measurement method for different operation characteristics. The mannequin body 11 may thus provide the same main platform across different training materials without the need to frequently replace different mannequin bodies.

In an embodiment, the sensing module 12 may establish a connection with the processing unit 13 through i²c or other general-purpose communication interfaces. This design enables the sensing module 12, which is composed of a plurality of sensors or different types of sensors, to be integrated into the intelligent care training system 1 in a standardized manner, facilitating future maintenance, upgrading, and expansion.

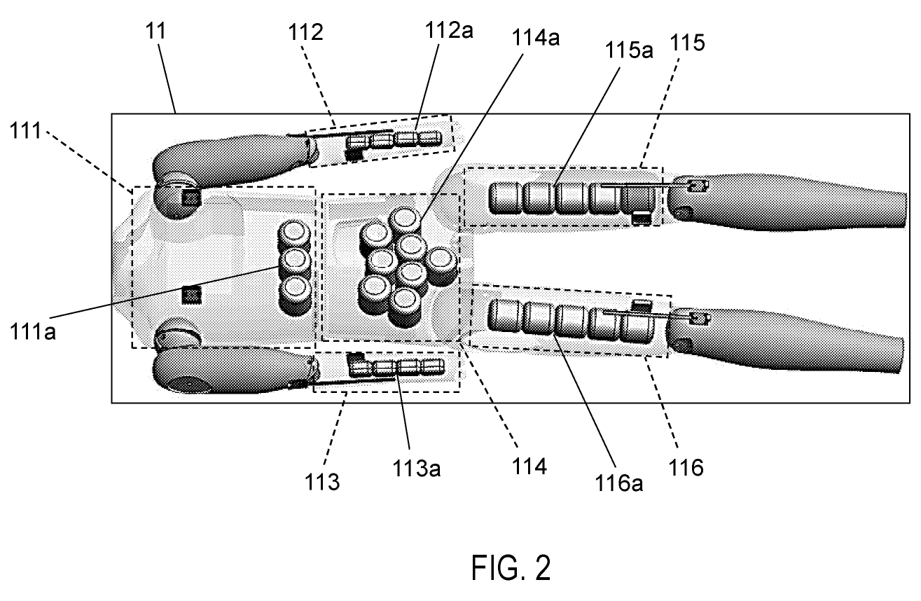

Next, the mannequin body 11 and its counterweight modules will be further introduced. Please refer to FIG. 2, in an embodiment, at least one cavity is formed inside the mannequin body 11, and the cavities may include a trunk cavity 111, a left upper-limb cavity 112, a right upper-limb cavity 113, an abdominal cavity 114, a left lower-limb cavity 115, a right lower-limb cavity 116, and the like, to accommodate different training materials and different requirements for human body center-of-gravity distribution.

In an embodiment, each of the trunk cavity 111, the left upper-limb cavity 112, the right upper-limb cavity 113, the abdominal cavity 114, the left lower-limb cavity 115, and the right lower-limb cavity 116 may be provided with a counterweight module to simulate the weight sensation and weight distribution of a care recipient. By distributing the weight across different parts rather than concentrating it in a single area, the realistic hand feel during turning-over, transfer, and holding operations may be improved. For example, a trunk counterweight module 111a is disposed in the trunk cavity 111 shown in FIG. 2, a left upper-limb counterweight module 112a is disposed in the left upper-limb cavity 112, a right upper-limb counterweight module 113a is disposed in the right upper-limb cavity 113, an abdominal counterweight module 114a is disposed in the abdominal cavity 114, a left lower-limb counterweight module 115a is disposed in the left lower-limb cavity 115, and a right lower-limb counterweight module 116a is disposed in the right lower-limb cavity 116. In an embodiment, each of the aforementioned counterweight modules may include at least one counterweight block. The aforementioned counterweight blocks may be added, reduced, replaced, or repositioned as needed, thereby adjusting the overall weight of the mannequin body and the center-of-gravity distribution of each part.

In an embodiment, each of the aforementioned counterweight blocks may be a sand bag, a lead shot bag, or other member having a predetermined weight. Counterweight blocks of different materials may be selected according to actual needs; for example, a lead shot bag may provide a higher-density weight, while a sand bag has better shape adaptability and filling properties.

In an embodiment, each of the aforementioned counterweight blocks may be wrapped and then placed into each cavity, and foam padding, adhesion, binding, or other fixing methods may be used to prevent displacement. This may prevent the counterweight blocks from sliding or striking the inner wall of the mannequin body during turning-over, holding, transfer, or bed entry/exit training.

In an embodiment, the counterweight module may form a configuration of independent counterweights for the limbs and an independent counterweight for the trunk. That is, the user may separately adjust the weight of the trunk cavity 111, the left upper-limb cavity 112, the right upper-limb cavity 113, the abdominal cavity 114, the left lower-limb cavity 115, and the right lower-limb cavity 116, so that the mannequin body 11 more closely approximates the weight distribution of different care recipients in real scenarios.

In an embodiment, the counterweight module may be configured asymmetrically to simulate hemiplegic patients, post-operative patients, or other scenarios with unilateral limitations. For example, the weights of the right upper-limb cavity 113 and the right lower-limb cavity 116 may be made greater than those of the left upper-limb cavity 112 and the left lower-limb cavity 115, or the weight on one side of the trunk may be concentrated, thereby making the training scenario more closely approximate real caregiving situations.

In an embodiment, the mannequin body 11 has a base weight of approximately 18 kilograms when no counterweight module is disposed in any of the cavities inside the mannequin body 11, and the weight may be increased to approximately 20 kilograms to 60 kilograms by adding the counterweight module. In other embodiments, a higher total weight may further be set to simulate a care recipient with a larger body size.

In an embodiment, the counterweight conditions may be adjusted according to different training materials, for example, to simulate different physical conditions or physical states such as obese, thin, atrophied, hemiplegic, post-operative, or long-term bedridden patients. Thereby, multiple levels of training material difficulty and risk scenarios may be established.

By means of the design of the aforementioned counterweight module, the present invention may enhance the realistic resistance sensation of turning-over, transfer, and high-risk caregiving motions, thereby improving the user's sensitivity to muscle strength application, body protection posture, and crisis management.

In an embodiment, the counterweight module is not merely a general static counterweight, but rather combines the requirements of caregiving scenarios to provide flexible counterweight arrangement and asymmetric configuration of the trunk and limbs. Compared to prior art that includes only a general human body model or a simple pressure-applying device, the present invention may more completely reflect the realistic caregiving resistance and center-of-gravity changes.

Continuing to refer to FIG. 1. In an embodiment, the sensing module 12 may include at least one sensing element selected from the group consisting of an inertial measurement unit (IMU), a pressure-array sensing pad, an optical sensor, a distance sensor, a bending sensing element, a pressure sensor, a tension sensor, and other sensing elements that may be used for caregiving motion detection. Different types of sensors may be used in combination according to course requirements.

In an embodiment, the inertial measurement unit may be used to detect the angle, angular velocity, posture change, or relative position of the trunk or limb of the mannequin body 11. Such information is particularly suitable for use in motion determination of turning-over, hand-lifting, foot-lifting, sitting up, and repositioning.

In an embodiment, the bending sensing element may be used to detect the degree of bending of the limb of the mannequin body 11, and may be used in combination with the output of the inertial measurement unit to improve the recognition accuracy of local motion patterns. For example, when the hand of the mannequin body 11 is lifted but the bending angle is insufficient, a single IMU alone may not be sufficient to fully recognize the motion, and the bending sensing element may compensate for the difference.

In an embodiment, the pressure-array sensing pad may be used to detect the tapping position, tapping force, tapping frequency/count, pressure distribution, and palm shape characteristics when the user taps the mannequin body 11. By collecting multi-point force information, it is possible to further expand from a simple determination of “whether or not tapping occurred” to a higher-level determination of “where the tapping occurred, how much force was applied, and whether the palm shape is correct.”

In an embodiment, the optical sensors may be used to detect the light attenuation caused by the clothing coverage of the mannequin body 11, and the distance sensors may be used to detect whether the clothing of the mannequin body 11 is approaching or covering a predetermined position. Through the combination of the two, the determination of the dressing/undressing process may be made less susceptible to the influence of clothing material, wrinkles, or partial occlusion.

In an embodiment, the pressure sensor or force sensor may be used to detect the grounding state, sitting state, or wheelchair positioning-related information of the mannequin body 11. When the feet of the mannequin body 11 correctly contact the wheelchair footrest or the ground, or when the mannequin body 11 has been moved close to the backrest of the wheelchair, the intelligent care training system 1 may confirm the transfer state of the mannequin body 11 through the signal of the sensing module 12.

In an embodiment, sensing elements are disposed on the trunk and limbs of the mannequin body 11, so that caregiving motions are no longer determined solely based on a single pressure input, but may instead be jointly analyzed by multi-point posture, force, coverage, and sequence information. Such a multi-sensor integration architecture may supplement the determination of motion completeness.

In an embodiment, the processing unit 13 may be a microcontroller unit (MCU), an embedded system, an edge computing module, a single-board computer, or other devices capable of executing data processing.

In an embodiment, the processing unit 13 may receive digital signals output by the sensing module 12, and perform relative position calculation, posture analysis, condition comparison, and model inference. By converting raw sensing data into comparable feature parameters, the intelligent care training system 1 is able to determine the correctness of care operations.

In an embodiment, the processing unit 13 may perform multi-sensor fusion based on the plurality of sensing elements included in the sensing module 12, that is, integrating and analyzing the digital signals of different sensing elements to improve the completeness and accuracy of the determination of the operation state. For example, when the user uses the mannequin body 11 for turning-over training, the processing unit 13 may simultaneously perform sensing data analysis based on IMU and bending sensing data; when the user uses the mannequin body 11 for back-patting training, the processing unit 13 may simultaneously perform sensing data analysis based on pressure position and palm shape data. When the user uses the mannequin body 11 for dressing/undressing training, the processing unit 13 may simultaneously perform sensing data analysis based on optical sensing and distance sensing data.

In an embodiment, the processing unit 13 may compare the sensing data with at least one predetermined operation condition to determine whether the care operation satisfies the expected training requirements. The predetermined operation condition may vary depending on different training materials, for example, turning-over training may emphasize angle and sequence, back-patting training may emphasize position, force, and speed, and the dressing/undressing module may emphasize coverage state and left-right sequence.

In an embodiment, the predetermined operation condition may include force, angle, position, sequence, time, count, speed, coverage state, sitting-up state, transfer state, and foot positioning state. By incorporating a plurality of conditions into the same determination mechanism, the intelligent care training system 1 may support the evaluation of single-step and multi-step composite motions.

In an embodiment, when the processing unit 13 is disposed inside the mannequin body 11, the processing unit 13 may perform edge computing on the mannequin body end without uploading all data to the cloud. Such an architecture helps to immediately output results at the training site and reduces teaching interruptions caused by network latency.

In another embodiment, when the processing unit 13 is disposed on an external platform outside the mannequin body 11, the processing unit 13 may send part of the data to the external platform or a server for online evaluation, statistical analysis, multi-person course management, and subsequent training record comparison. Such a dual-track architecture enables the present invention to possess both edge real-time capability and platform-based management capability.

In an embodiment, the feedback module 14 may include a voice output unit 141 and a display unit 142, and may output a corresponding feedback signal according to the operation determination result. When the user performs an operation correctly, an encouragement or completion message may be output; when the user performs an operation incorrectly, an error prompt or correction suggestion may be output.

In an embodiment, the feedback module 14 may include only the voice output unit 141 and the display unit 142, and may further be combined with a tablet, a computer, a web interface, or an extended reality output device to satisfy the equipment conditions of different environments.

In an embodiment, the intelligent care training system 1 may further include a training data recording module 15 and an operation unit 16. The training data recording module 15 may be used to record the training process and results. It may record the operation start and end time, whether each sub-motion is completed, error type, error occurrence time point, completion percentage, and scoring result.

In an embodiment, the record content may further include a palm shape recognition result, an incorrect tapping area, whether the affected side/unaffected side sequence is correct, whether the transfer is completed, and/or deduction information in an examination mode. In this way, the intelligent care training system 1 not only records whether the operation is completed, but also preserves the details and types of errors.

In an embodiment, the intelligent care training system 1 may automatically generate a training report or a digital portfolio based on the content of the training data recording module 15 for tracking by the user, a teacher, or an administrator. Such digital portfolios may be used to evaluate progress, analyze the distribution of errors, and analyze the learning effectiveness of different training materials.

In an embodiment, the operation unit 16 may be a part of an external operation interface and may present information in coordination with the feedback module 14. In an embodiment, the operation unit 16 may display a training material process, a current step, a completion percentage, an error location, an error type, historical records, a scoring result, suggested correction information, and/or guidance information. When combined with a tablet or a web interface, a more complete graphical operation interface may also be provided.

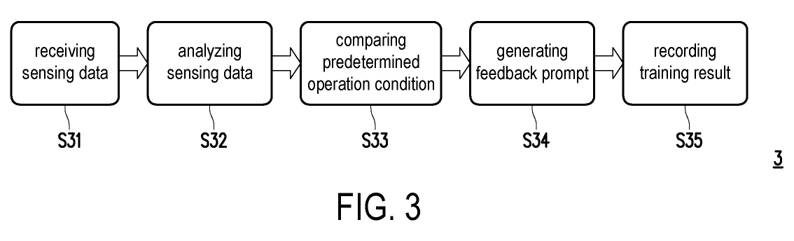

Please refer to FIG. 3. The intelligent care training method 3 of FIG. 3 may be executed by the processing unit 13 of the intelligent care training system 1 of FIG. 1. In an embodiment, the intelligent care training method 3 may include steps S31 to S35.

In step S31, the processing unit 13 receives the sensing data from the sensing module 12. In step S32, the processing unit 13 analyzes the sensing data. In step S33, the processing unit 13 compares the sensing data with at least one predetermined operation condition to determine whether the care operation satisfies the expected training requirements. In step S34, the processing unit 13 generates a feedback prompt. In step S35, the processing unit 13 records the training result in the training data recording module 15. Next, the intelligent care training system 1 and the intelligent care training method 3 will be further introduced when the user uses the mannequin body 11 for various types of training.

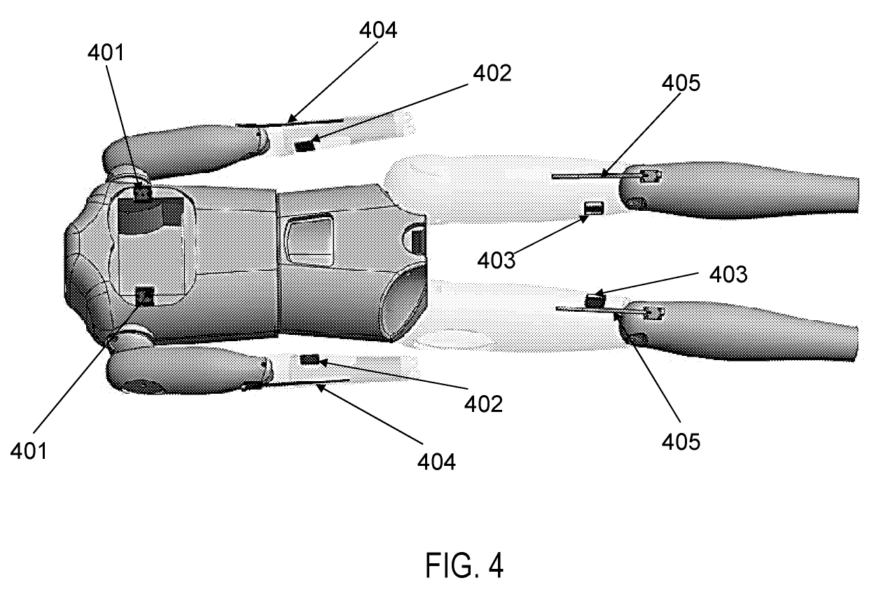

Please refer to FIG. 4. In an embodiment, the turning-over operation included in the turning-over training of the present invention may include three main sub-motions: hand-lifting (elbow bending), foot-lifting (knee bending), and body turning-over, so as to convert complex caregiving motions into teaching steps that may be individually measured and determined.

In an embodiment, one or two inertial measurement units 401 may be disposed at the chest area of the mannequin body 11 to detect changes in the trunk posture. By measuring the angle change of the trunk from lying flat, lying on the side, to sitting up or turning over using one or two inertial measurement units 401, the processing unit 13 may determine whether the main posture transition of the turning-over motion has been completed. For example, during turning-over training, the angle between the back of the mannequin body 11 and the bed surface should be 30 to 90 degrees.

In an embodiment, one inertial measurement unit 402 may be disposed at each of the two forearms, upper arms, or other limb areas of the mannequin body 11, and the inclination angle between the inertial measurement unit 402 and the inertial measurement unit 401 disposed at the chest area may be measured to detect elbow bending, the motion of lifting the arm to the front of the chest, and relative angle changes. For example, during hand-lifting, the angle between the forearm and the upper arm of the mannequin body 11 should be 90±45 degrees. When the user moves the arm of the mannequin body 11 according to the training material requirements, the processing unit 13 may determine the degree of completion of hand-lifting (elbow bending) through the aforementioned sensing data.

In addition, bending both knees is usually an important preparatory motion before turning over, so whether both knees are bent to a certain angle may serve as an important basis for determining whether the foot-lifting step has been completed. In an embodiment, one inertial measurement unit 403 may be disposed at each of the two leg areas of the mannequin body 11, and the inclination angle between the inertial measurement unit 403 and the inertial measurement unit 401 disposed at the chest area may be measured to detect the motion of lifting and bending the leg upward and relative angle changes. For example, during foot-lifting, the angle at both knees between the thigh and the lower leg of the mannequin body 11 should be less than 90 degrees. When the user bends both knees of the mannequin body 11 according to the training material requirements, the processing unit 13 may determine the degree of completion of foot-lifting (knee bending) through the aforementioned sensing data.

In order to more accurately determine the angle of elbow bending and knee bending, in an embodiment, bending sensing elements 404 may be disposed at the forearm and upper arm of the mannequin body 11, and bending sensing elements 405 may be disposed at the thigh and lower leg of the mannequin body 11, to detect the state of elbow bending, leg lifting, or knee bending. When the bending sensing elements 404 and 405 are disposed on the mannequin body 11, the inertial measurement units 402 and 403 may detect the displacement of the forearm, upper arm, thigh, and lower leg, so that the processing unit 13 may more accurately determine the degree of completion of the three main sub-motions of hand-lifting (elbow bending), foot-lifting (knee bending), and body turning-over through the inertial measurement units 401, 402, 403 and the bending sensing elements 404, 405.

In an embodiment, the processing unit 13 may determine, based on the trunk posture change and the limb motion state, whether at least one of the hand-lifting state, the foot-lifting state, and the turning-over state of the turning-over operation satisfies the predetermined operation condition. When all three satisfy the predetermined operation condition, the turning-over operation may be determined to be completed.

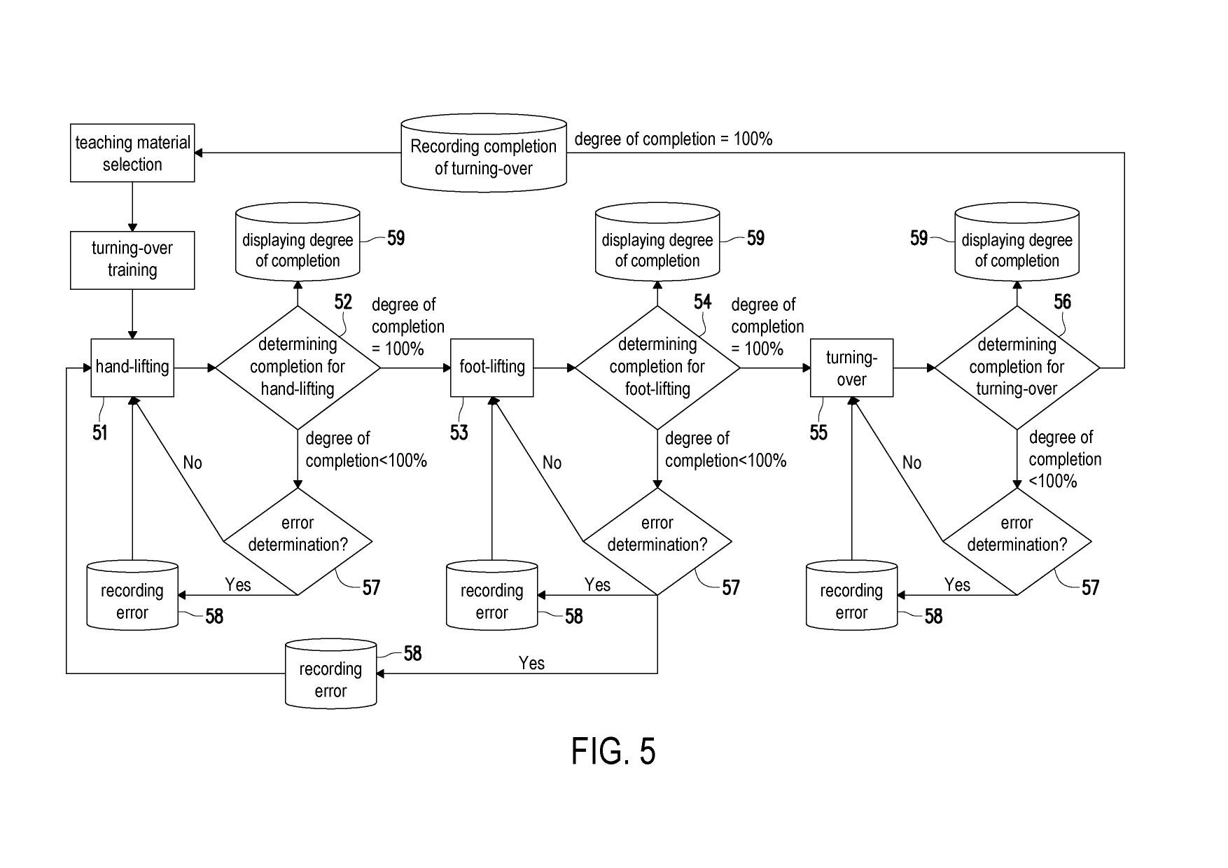

Please refer to FIG. 5. In an embodiment, when the user uses the mannequin body 11 to perform turning-over training, a training material selection is executed through the operation unit 16 to enter the turning-over training process. The turning-over training process may include detecting hand-lifting 51, determining the degree of completion of hand-lifting 52, detecting foot-lifting 53, determining the degree of completion of foot-lifting 54, detecting turning-over 55, determining the degree of completion of turning-over 56, error determination 57, recording an error 58, and displaying the degree of completion of turning-over training 59. By decomposing the turning-over operation into a plurality of sub-steps, the intelligent care training system 1 and the intelligent care training method 3 may gradually guide the user to complete the turning-over training, rather than providing only a single result after the training is completed.

In an embodiment, after the user selects the turning-over training material, the processing unit 13 may firstly perform detecting hand-lifting 51 based on the sensing data generated by the sensing module 12, and perform determining the degree of completion of hand-lifting 52. If the hand-lifting motion satisfies the predetermined operation condition, the degree of completion of the sub-step may be displayed as 100%; if the predetermined operation condition is not satisfied, the completion may be displayed as being less than 100%.

In an embodiment, after determining the degree of completion of hand-lifting 52 is completed, the processing unit 13 may further perform detecting foot-lifting 53, and perform determining the degree of completion of foot-lifting 54. If the foot-lifting motion satisfies the predetermined operation condition, the degree of completion of the sub-step may be displayed as 100%; if the predetermined operation condition is not satisfied, the completion may be displayed as being less than 100%.

In an embodiment, after determining the degree of completion of foot-lifting 54 is completed, the processing unit 13 may further perform detecting turning-over 55, and perform determining the degree of completion of turning-over 56. If the turning-over motion satisfies the predetermined operation condition, the degree of completion of the sub-step may be displayed as 100%; if the predetermined operation condition is not satisfied, the degree of completion may be displayed as being less than 100%.

In an embodiment, in each of the sub-steps such as detecting hand-lifting 51, detecting foot-lifting 53, and detecting turning-over 55, the processing unit 13 may simultaneously perform error determination 57. When it is determined that the user's operation has an error, recording an error 58 may be executed to record the error content in the training data recording module 15, and an error prompt may be output through the feedback module 14 for the user to perform immediate correction.

In an embodiment, displaying the degree of completion of turning-over training 59 may be used to display the completion status of each sub-step or the completion status of the overall turning-over training. That is, when any sub-step of hand-lifting, foot-lifting, or turning-over has not yet been completed, then display the degree of completion less than 100%; when each sub-step satisfies the predetermined operation condition, the degree of overall completion of turning-over training may be displayed as 100%.

In an embodiment, when all three sub-steps of hand-lifting, foot-lifting, and turning-over satisfy the predetermined operation conditions, the processing unit 13 may determine that the turning-over training is completed, and record completion of turning-over in the training data recording module 15. In some embodiments, the intelligent care training system 1 may also output the degree of completion of each sub-step, the error count, and the final completion result through the feedback module 14.

In an embodiment, the sequence of detecting hand-lifting 51 and detecting foot-lifting 53 may be adjusted according to the training material requirements. That is, the intelligent care training system 1 may first perform detecting hand-lifting 51 and then perform detecting foot-lifting 53, or first perform detecting foot-lifting 53 and then perform detecting hand-lifting 51. However, regardless of the sequence, the primary purpose of the aforementioned sub-steps is to establish an appropriate force-applied fulcrum and preparatory posture before turning-over.

In an embodiment, the processing unit 13 may record the results of determining the degree of completion of hand-lifting 52, determining the degree of completion of foot-lifting 54, and determining the degree of completion of turning-over 56 in the training data recording module 15. If any sub-motion of detecting hand-lifting 51, detecting foot-lifting 53, or detecting turning-over 55 does not satisfy the predetermined operation condition, the processing unit 13 may record an error, and then the degree of completion may be displayed as being less than 100% on the display unit 142. The information of the degree of completion may prompt the user through the feedback module 14 regarding the motion phase that still requires correction.

In an embodiment, if the turning-over motion is completed, the degree of completion of turning-over training may be recorded in the training data recording module 15, and the degree of completion may be displayed as 100%. If the intelligent care training system 1 is simultaneously in an online mode, the completion information may also be synchronously uploaded to an external platform for subsequent training management, performance analysis, teaching tracking, or displaying completion.

In an embodiment, the predetermined operation conditions of the turning-over training may include the relative angle of the arm, the degree of bending of the leg, the turning-over angle, the motion sequence, and the time interval between each step. In another embodiment, the aforementioned threshold values may also be adjusted according to the teaching requirements of elderly individuals, hemiplegic individuals, or post-operative patients. In yet another embodiment, the turning-over training may further be combined with positioning training materials as an extended caregiving teaching after turning-over, that is, after the turning-over motion is completed, the intelligent care training system 1 may further determine whether the user positions the mannequin body 11 in an appropriate posture.

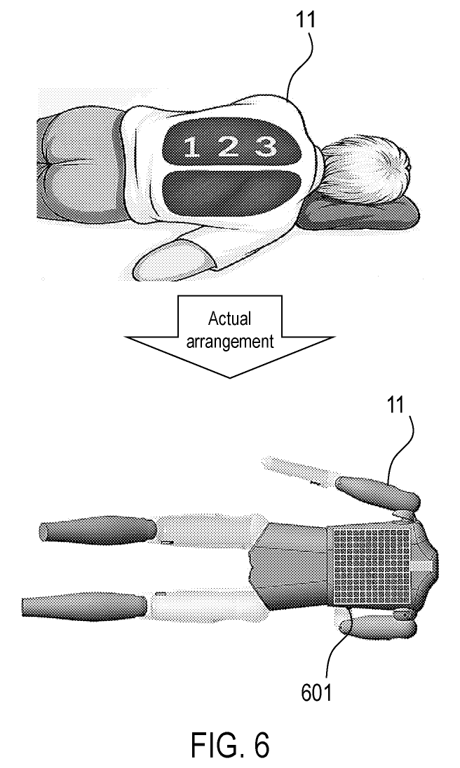

Please refer to FIG. 6. Since the user needs to perform a turning-over motion on the mannequin body 11 before performing back-patting training on the mannequin body 11, in addition to disposing the inertial measurement units 401, 402, 403 and/or bending sensing elements 404, 405 as illustrated in FIG. 4 on the mannequin body 11, in an embodiment, a pressure-array sensing pad 601 may be disposed on the back of the mannequin body 11 to capture the position, force, frequency, and pressure distribution when tapping the back of the mannequin body 11. For clarity, FIG. 6 only illustrates the pressure-array sensing pad 601.

In an embodiment, the back region of the mannequin body 11 may be divided into tapping regions corresponding to the lower lung lobe (the region labeled “1” in FIG. 6), the middle lung lobe (the region labeled “2” in FIG. 6), and the upper lung lobe (the region labeled “3” in FIG. 6). Thereby, the intelligent care training system 1 may determine whether the user performs back-patting in the correct sequence according to the training material requirements. For example, the processing unit 13 may determine, based on the pressure sensing data of the pressure-array sensing pad 601, whether the user taps the mannequin body 11 in the sequence from the lower lung lobe to the middle lung lobe and then to the upper lung lobe. When the processing unit 13 detects that the user directly starts tapping from the upper lung lobe, or skips the lower lung lobe or the middle lung lobe, the sequence may be determined as incorrect.

In an embodiment, the processing unit 13 may determine, based on the pressure sensing data of the pressure-array sensing pad 601, whether the force applied by the user when tapping the mannequin body 11 satisfies the predetermined operation condition. A force that is too small may be insufficient to achieve the training purpose, while a force that is too large may cause improper application; therefore, both may be marked as an error by the processing unit 13.

In an embodiment, the processing unit 13 may determine, based on the count of taps applied by the user on the mannequin body 11 per unit time or the tapping status within a designated time, whether the tapping speed or frequency of the user satisfies the predetermined operation condition. In an embodiment, the tapping frequency may, for example, be set to approximately two taps per second, but is not limited thereto.

In an embodiment, the processing unit 13 may compare the pressure sensing data of the pressure-array sensing pad 601 with a palm shape condition to determine whether the palm shape of the user when tapping satisfies the predetermined operation condition. The palm shape for tapping in the predetermined operation condition may be a cupped palm, an arched palm, or other forms suitable for the training material settings.

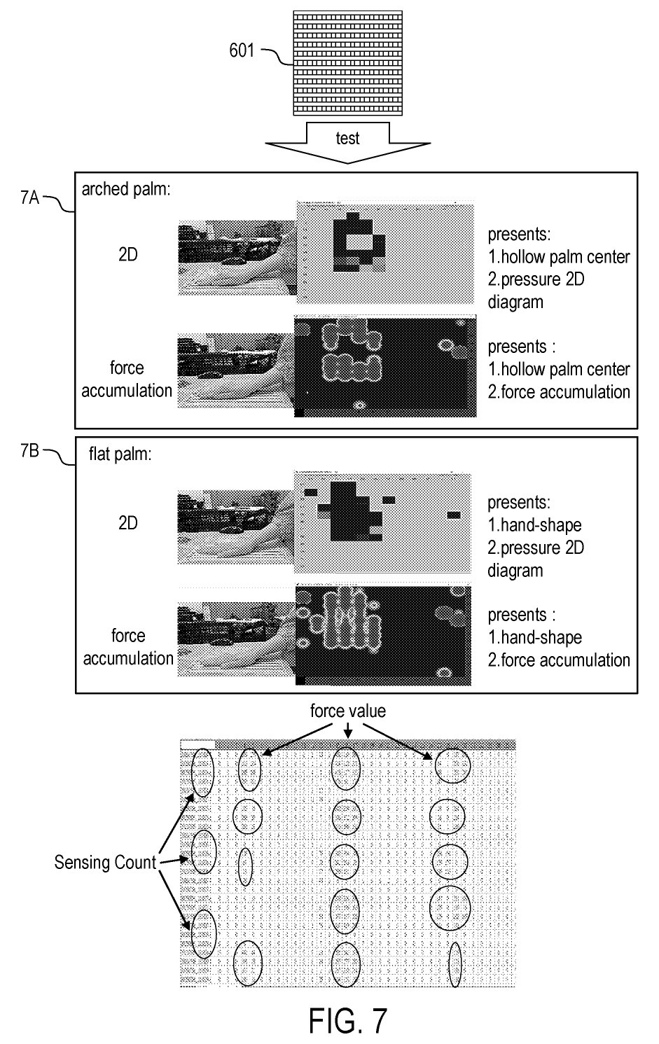

Please refer to FIG. 7. In an embodiment, the pressure data of the back-patting operation may further be used for palm shape recognition. The pressure data may include a pressure 2D map, a force accumulation diagram, a sensing count and force values, and the like, which are used to describe the force characteristics when tapping.

In an embodiment, when the user taps the back of the mannequin body 11 with an arched palm or a cupped palm (block 7A), the pressure distribution presents a hollow palm center characteristic, and it may be seen that the pressure 2D map presented by the pressure sensing data in block 7A shows a hollow pattern; when the user taps the back of the mannequin body 11 with a flat palm (block 7B), the pressure distribution presents a hand-shape characteristic, and it may be seen that the pressure 2D map presented by the pressure sensing data in block 7B shows a solid pattern. The processing unit 13 may utilize the difference in the pressure sensing data to determine whether the palm shape of the user when tapping the back of the mannequin body 11 satisfies the teaching requirements. In an embodiment, the pressure-array sensing pad 601 may adjust its size and resolution according to the size of the mannequin body 11 and the requirements of the tapping region.

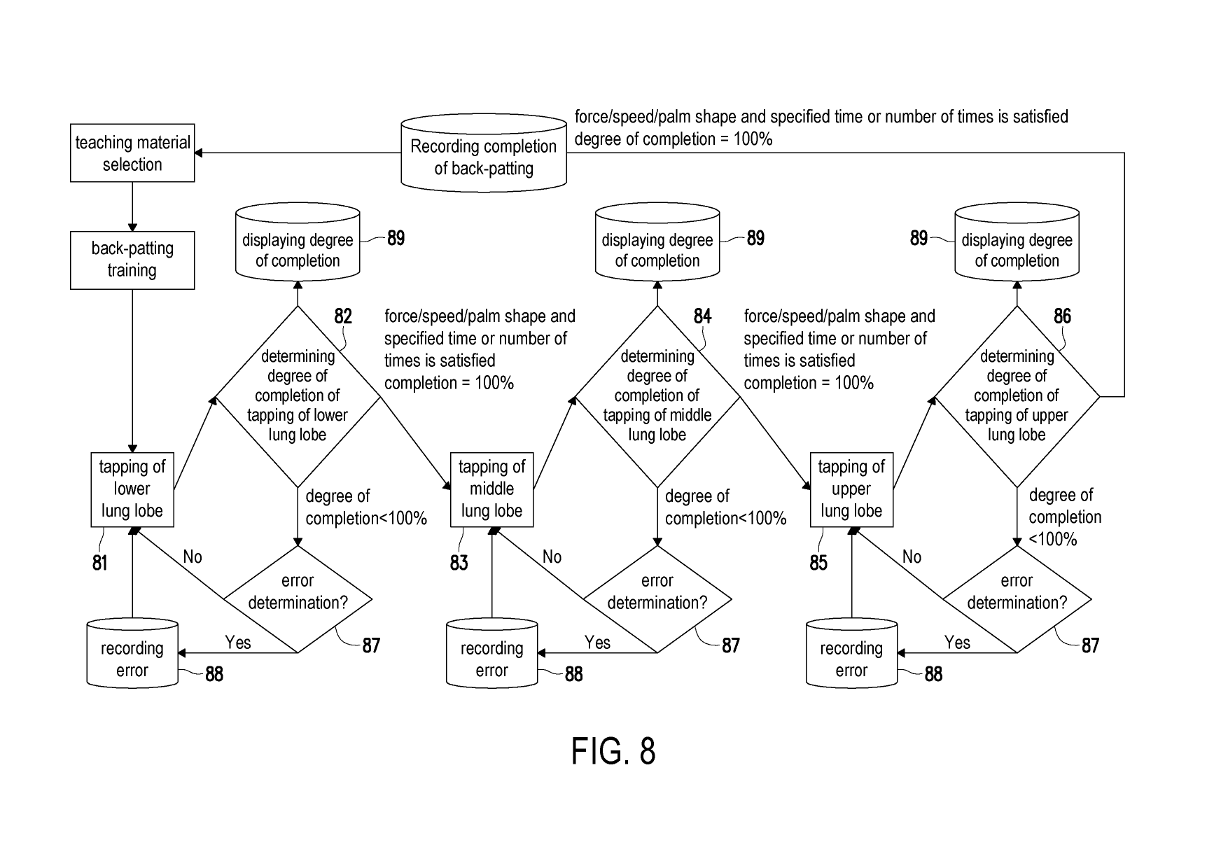

Please refer to FIG. 8. In an embodiment, when the user uses the mannequin body 11 to perform back-patting training, the user may perform training material selection through the operation unit 16 to enter the back-patting training process. The back-patting training process may include detecting tapping of the lower lung lobe 81, determining the degree of completion of tapping of the lower lung lobe 82, detecting tapping of the middle lung lobe 83, determining the degree of completion of tapping of the middle lung lobe 84, detecting tapping of the upper lung lobe 85, determining the degree of completion of tapping of the upper lung lobe 86, error determination 87, recording an error 88, and displaying the degree of completion of back-patting training 89. By decomposing the back-patting operation into a plurality of sub-steps, the intelligent care training system 1 may gradually guide the user to complete the back-patting training, rather than providing only a single result after the training ends.

In an embodiment, after the user enters the back-patting training process, the processing unit 13 may first execute detecting tapping of the lower lung lobe 81 based on the pressure sensing data generated by the pressure-array sensing pad 601, and perform determining the degree of completion of tapping of the lower lung lobe 82. If the tapping position, force, speed, and palm shape of the user in the lower lung lobe region all satisfy the predetermined operation condition, and the specified time or number of times is satisfied, then the sub-step may be determined as completed, and the degree of completion of the sub-step may be displayed as 100%; if the aforementioned predetermined operation condition is not satisfied, then the degree of completion of the sub-step may be displayed as less than 100%.

In an embodiment, after determining the degree of completion of tapping of the lower lung lobe 82 is completed, the processing unit 13 may further execute detecting tapping of the middle lung lobe 83, and perform determining the degree of completion of tapping of the middle lung lobe 84. If the tapping position, force, speed, and palm shape of the user in the middle lung lobe region all satisfy the predetermined operation condition, and the specified time or number of times is satisfied, then the sub-step may be determined as completed, and the degree of completion of the sub-step may be displayed as 100%; if the aforementioned predetermined operation condition is not satisfied, then the degree of completion of the sub-step may be displayed as less than 100%.

In an embodiment, after determining the degree of completion of tapping of the middle lung lobe 84 is completed, the processing unit 13 may further execute detecting tapping of the upper lung lobe 85, and perform determining the degree of completion of tapping of the upper lung lobe 86. If the tapping position, force, speed, and palm shape of the user in the upper lung lobe region all satisfy the predetermined operation condition, and the specified time or number of times is satisfied, then the sub-step may be determined as completed, and the degree of completion of the sub-step may be displayed as 100%; if the aforementioned predetermined operation condition is not satisfied, then the degree of completion of the sub-step may be displayed as less than 100%.

In an embodiment, in each of the sub-steps such as detecting tapping of the lower lung lobe 81, detecting tapping of the middle lung lobe 83, and detecting tapping of the upper lung lobe 85, the processing unit 13 may simultaneously execute error determination 87. When it is determined that the user's operation has an error, recording an error 88 may be executed, the error content may be recorded in the training data recording module 15, and an error prompt may be output through the feedback module 14 for the user to perform immediate correction.

In an embodiment, the error content corresponding to error determination 87 may include a position error, a force error, a speed error, and a palm shape error. In some embodiments, the system may also additionally set prohibited tapping regions, for example, the spinal region or the region near the waist. When the user performs tapping and the tapping position falls within the aforementioned prohibited tapping region, the processing unit 13 may determine it as an error, and immediately output a warning through the display unit 142 and/or the voice output unit 141 to remind the user to perform correction of the back-patting habit.

In an embodiment, displaying the degree of completion of back-patting training 89 may be used to display the completion status of each tapping region or the completion status of the overall back-patting training. That is, when any one of the tapping regions of the lower lung lobe, the middle lung lobe, or the upper lung lobe has not yet been completed, the degree of completion may be displayed as less than 100%; conversely, when the tapping position, force, speed, palm shape, and specified time or number of times of the three tapping regions of the lower lung lobe, the middle lung lobe, and the upper lung lobe all satisfy the predetermined operation condition, then the degree of overall completion of back-patting training may be displayed as 100%.

In an embodiment, when the three tapping regions of the lower lung lobe, the middle lung lobe, and the upper lung lobe all satisfy the predetermined operation condition, the processing unit 13 may determine that the back-patting training is completed, and record of completion of back-patting in the training data recording module 15.

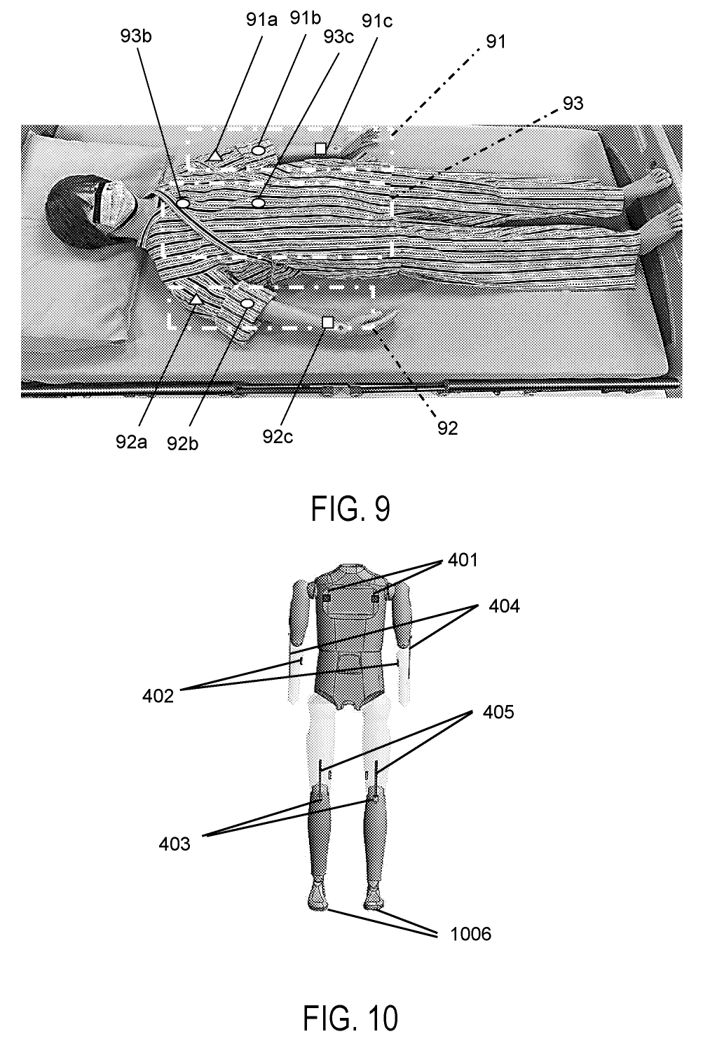

In an embodiment, the intelligent care training system 1 and the intelligent care training method 3 of the present invention, in addition to including turning-over training and back-patting training, may further include dressing/undressing training. Please refer to FIG. 9, in an embodiment, sensing elements may be disposed in a left dressing/undressing sensing area 91, a right dressing/undressing sensing area 92, and a middle covering area 93 on the front side of the mannequin body 11, to detect whether clothing covers a predetermined position. The left dressing/undressing sensing area 91 is provided with a distance sensor 91a, an optical sensor 91b, and an optical sensor 91c, the right dressing/undressing sensing area 92 is provided with a distance sensor 92a, an optical sensor 92b, and an optical sensor 92c, and the middle covering area 93 is provided with an optical sensor 93b and an optical sensor 93c. Wherein, the distance sensors of the left dressing/undressing sensing area 91 and the right dressing/undressing sensing area 92 may be used to confirm whether the clothing is put on from the side, and the optical sensors may be used to confirm the sleeve-rolling and insertion status; the optical sensors of the middle covering area 93 may be used to confirm whether the middle portion of the clothing is indeed covered. In an embodiment, the clothing used in the aforementioned dressing/undressing training may be a patient gown or other clothing for care training.

In an embodiment, when the left dressing/undressing sensing area 91, the right dressing/undressing sensing area 92, and the middle covering area 93 of the mannequin body 11 are all covered by clothing, the optical sensors 91b, 91c, 92b, 92c, 93b, 93c will generate corresponding sensing data due to light attenuation, and the processing unit 13 may determine, based on the sensing data of the optical sensors 91b, 91c, 92b, 92c, 93b, 93c, whether the left dressing/undressing sensing area 91, the right dressing/undressing sensing area 92, or the middle covering area 93 of the mannequin body 11 is covered by clothing in place. When only a partial region of the mannequin body 11 is covered by clothing or only one layer of clothing is covered, the degree of light attenuation may not yet reach a predetermined threshold, and the processing unit 13 may determine, based on the sensing data of the optical sensors 91b, 91c, 92b, 92c, 93b, 93c, that the mannequin body 11 is not correctly covered by clothing; when the mannequin body 11 is covered by clothing of two or more layers, and the degree of light attenuation reaches the predetermined threshold, the processing unit 13 may determine, based on the sensing data of the optical sensors 91b, 91c, 92b, 92c, 93b, 93c, that the mannequin body 11 is correctly covered by clothing.

In an embodiment, the distance sensors 91a, 92a may assist in detecting whether the clothing of the mannequin body 11 is close to or covers the cuff, arm, chest, or other predetermined positions. Specifically, the distance sensors 91a, 92a of the left dressing/undressing sensing area 91 and the right dressing/undressing sensing area 92 may be used to detect whether the clothing has been worn to a predetermined position of the corresponding shoulder, upper arm, or arm path, to assist in determining whether the clothing has been correctly put on. At certain positions, optical sensors (for example, optical sensors 91c, 92c, 93b, 93c) may be used alone; at other positions, optical sensors (for example, optical sensors 91b, 92b) may be used together with distance sensors for joint determination, to improve the accuracy of determining the dressing/undressing status.

In an embodiment, the processing unit 13 may avoid incorrectly recognizing that dressing has been completed merely due to blocking of a single sensing element, by means of a comprehensive determination of a plurality of sensing points. For example, if the clothing only covers the middle covering area 93 but has not completely passed through the left arm position of the left dressing/undressing sensing area 91 or the right arm position of the right dressing/undressing sensing area 92, the processing unit 13 may still determine that the dressing/undressing training has not yet been completed. In an embodiment, the comprehensive determination of the aforementioned plurality of sensing points may reduce misjudgments caused by clothing wrinkles, partial blocking, or false triggering of a single sensing point.

In an embodiment, when the dressing/undressing training is directed at a care recipient who has both an affected side and an unaffected side, the processing unit 13 may determine, based on the covering sequence, whether the condition of the dressing/undressing sequence is met, that is, the condition of dressing the affected side first and the unaffected side later, and/or undressing the unaffected side first and the affected side later. By embedding care ethics and technical process into the training material, the practicality of training may be improved. In an embodiment, the feedback module 14 may further output corresponding voice prompts or display prompts based on the dressing/undressing process, including prompt content such as dressing start, dressing end, undressing start, undressing end, clothing arrangement start, and clothing arrangement end.

In an embodiment, if the user performs the dressing/undressing training in an incorrect sequence, a prompt may be output via the feedback module 14, and the error may be recorded in the training data recording module 15. The feedback module 14 may also simultaneously present the type of the current error, such as “incorrect affected side/unaffected side sequence” or “coverage not in place.” In an embodiment, when the user incorrectly dresses the unaffected side first, incorrectly undresses the affected side first, or fails to complete clothing arrangement, the feedback module 14 may also output a corresponding voice prompt or display prompt to remind the user to make an immediate correction.

In an embodiment, the intelligent care training system 1 and the intelligent care training method 3 of the present invention may further include bed entry/exit and transfer training. Please refer to FIG. 10, in an embodiment, the operations included in the bed entry/exit and transfer training of the present invention may include three main stages of sitting up, transfer, and foot positioning, and may further be combined with the determination of wheelchair seating and backrest positioning.

Since the user must first perform a turning-over motion on the mannequin body 11 before performing bed entry/exit and transfer training on the mannequin body 11, in addition to disposing inertial measurement units 401, 402, 403 and/or bending sensing elements 404, 405 as illustrated in FIG. 4 on the mannequin body 11, in an embodiment, a measurement unit 1006 may be disposed on the soles of both feet of the mannequin body 11 to detect the grounding, force-bearing, or positioning state of the feet of the mannequin body 11, wherein the measurement unit 1006 may be a sensor such as a pressure sensor, a force sensor, an optical sensor, or a distance sensor, as long as it is capable of sensing the state change of the mannequin body 11 from the process of sitting up to the grounding of the feet or the foot positioning.

In an embodiment, in the bed entry/exit and transfer training, sitting up, transfer, and foot positioning may correspond to a first predetermined posture condition, a second predetermined transfer condition, and a third predetermined foot positioning condition, respectively. By decomposing the complex transfer process into a plurality of measurable conditions, the intelligent care training system 1 may more clearly indicate the step in which the user's error occurs.

In an embodiment, the first predetermined posture condition may include an angle range between the trunk of the mannequin body 11 and the bed surface during the process of the trunk transitioning from a lying posture to a sitting posture. For example, when the angle between the trunk and the bed surface gradually increases from a smaller angle to an angle range approaching a sitting posture, the intelligent care training system 1 may determine whether sitting up has been completed.

In an embodiment, the second predetermined transfer condition may include the path, posture change, or completion state of the transfer or repositioning process in which the user holds the mannequin body 11. If the user does not perform the repositioning according to the predetermined path, does not allow both feet of the mannequin body 11 to stably contact the ground to distribute the weight, or causes the center of gravity of the mannequin body 11 to become unbalanced midway, such actions may be regarded as not satisfying the condition.

In an embodiment, the third predetermined foot positioning condition may include whether both feet of the mannequin body 11 are stepping on a predetermined area, whether both feet are positioned on the wheelchair footrest, whether both feet are positioned at an appropriate position in front of the wheelchair, and whether the mannequin body 11 is correctly seated at an appropriate position on the wheelchair cushion and backrest. When both feet and the back of the mannequin body 11 are not in the correct positions, the intelligent care training system 1 may prompt the user to make a correction.

In an embodiment, the processing unit 13 may comprehensively determine whether the bed entry/exit or transfer training has been completed based on the trunk posture data, leg bending data, and foot sensing data of the mannequin body 11. Since bed entry/exit and transfer training involves composite motions, the aforementioned comprehensive determination may improve the reliability of the result.

In an embodiment, the processing unit 13 may also convert the sensing data into curves or into detailed sub-action segments to determine whether the process of the mannequin body 11 sitting up and transferring is smooth. If the curves indicate that the posture changes too quickly, there are too many pauses, the center of gravity transition is unstable, or the decomposed motion segments are incorrect, such conditions may further be regarded as potential errors.

In an embodiment, the bed entry/exit and transfer module training may be integrated with turning-over training, dressing/undressing training, or wheelchair operation training into a continuous care training material, enabling the user to practice composite tasks that are closer to the actual care process.

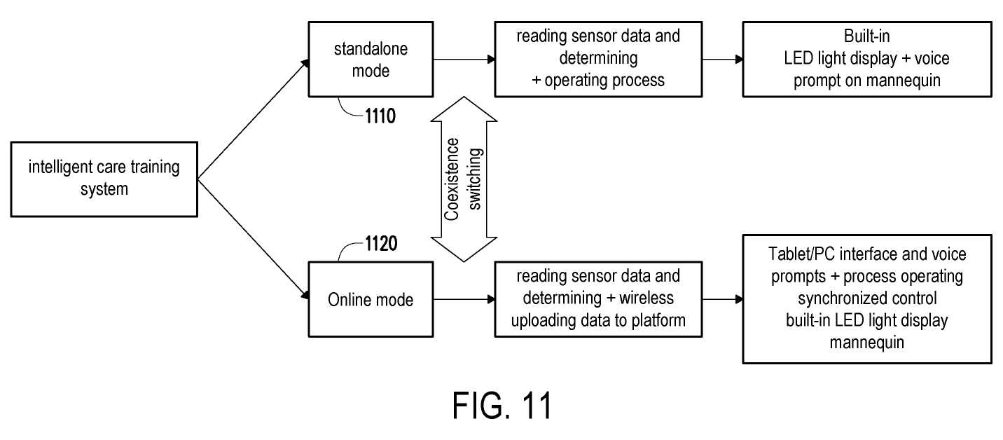

Please refer to FIG. 11, in an embodiment, the present invention may have a standalone mode 1110 and an online mode 1120. The two may share the same mannequin body, the same sensing module, and at least some of the same hardware elements, and may be switched for use according to operational requirements.

In the standalone mode 1110, the processing unit 13 disposed inside the mannequin body 11 may directly read the sensing data generated by the sensing module 12, and execute data determination and operation process control. After the determination result is generated, feedback prompts, error reminders, or operation guidance may be directly provided through the feedback module 14 built into the mannequin body 11, without relying on an external tablet, computer, or network connection. For example, the voice output unit 141 outputs a voice prompt, and the display unit 142 displays instruction information; in an embodiment, the display unit 142 may be an LED indicator light. Thereby, the user may perform autonomous training in a standalone environment.

In the online mode 1120, the processing unit 13 of the mannequin body 11 may directly read the sensing data generated by the sensing module 12, and further transmit the sensing data to an external operation interface, such as a tablet, a computer, or other networked devices, to execute training material process display, voice prompts, operation guidance, result display, and data upload. In the online mode 1120, the determination of the sensing data may be executed locally on the mannequin body 11, or may be executed on an external device or platform, and the determination result may be transmitted back to the external operation interface for display.

In an embodiment, the standalone mode 1110 and the online mode 1120 may be switched through a synchronization control mechanism and/or a mode switching mechanism, enabling the same set of hardware and sensors to operate independently inside the mannequin body 11 or to operate in connection with an external interface and platform according to requirements. Thereby, the need to repeatedly build two different systems may be avoided, and the versatility and use elasticity of the overall system may be improved.

By means of the aforementioned dual-mode architecture, the intelligent care training system 1 of the present invention may simultaneously satisfy the requirements of standalone autonomous training and platform-based teaching management. That is, in the absence of a network or external devices, the user may still complete basic training through the standalone mode 1110; while in a teaching or management setting, the user may obtain more complete training material guidance, result display, and training data recording functions through the online mode 1120.

In an embodiment, the feedback module 14 may further include an LLM voice engine and a mixed reality (MR) display device, which, upon receiving an instruction from the processing unit 13, output voice guidance or virtual visual indications, such as luminous arrows.

In an embodiment, the present invention may further incorporate a mixed reality head-mounted device, enabling virtual prompts to be overlaid on the actual mannequin body 11. In this case, the user may directly see arrows, markers, step frames, or notes above the actual operation position.

In a specific embodiment, a mixed reality head-mounted device, such as Quest 3, may be utilized to detect the limbs or positions of the mannequin body 11, so as to determine the operation position to be executed. In another embodiment, a handle or controller may also be bound to the mannequin body 11 to provide more precise positioning.

In an embodiment, the present invention may incorporate MR virtual-real integrated interaction and active voice feedback, enabling the trainer to obtain more intuitive guidance during the operation process. This structure combining a physical mannequin body, a sensing module, and virtual guidance distinguishes the present invention from devices that only provide first-aid augmented reality or only support a single training scenario.

The above descriptions are merely preferred embodiments of the present invention and are not intended to limit the protection scope of the present invention. Any equivalent modifications or variations made by a person having ordinary knowledge in the technical field to which the present invention pertains, without departing from the spirit and scope of the present invention, shall be encompassed within the protection scope of the present invention.

What is claimed is:

1. An intelligent care training system, comprising:
a mannequin body having a trunk and a plurality of limbs, and provided with at least one counterweight module;
a sensing module disposed on the mannequin body, and comprising:
a first sensor disposed on the trunk, configured to detect a posture change of the trunk; and
at least one second sensor respectively disposed on at least part of the plurality of limbs, configured to detect motion states of the at least part of the plurality of limbs, wherein the first sensor and the second sensor are configured to generate sensing data when a user performs a care operation on the mannequin body;
a processing unit electrically connected to the sensing module, and configured to determine an operation state of the care operation based on the sensing data; and
a feedback module electrically connected to the processing unit, and configured to output a feedback signal based on the operation state;
wherein the processing unit compares the sensing data with at least one predetermined operation condition to determine whether the care operation satisfies an expected training requirement, and when the care operation comprises a turning-over operation, the processing unit determines, based on the posture change of the trunk detected by the first sensor and the motion states of the at least part of the plurality of limbs detected by the second sensors, whether at least one of a hand-lifting state, a foot-lifting state, and a turning-over state of the turning-over operation satisfies the at least one predetermined operation condition.

2. The intelligent care training system according to claim 1, wherein the at least one counterweight module is respectively disposed inside at least part of the trunk and the plurality of limbs, to form a configuration of trunk counterweight and limb counterweight.

3. The intelligent care training system according to claim 2, wherein the at least one counterweight module is adjustable in counterweight size and counterweight distribution, to simulate a body type, a human body center of gravity distribution, physical conditions, or physical states of different care recipients.

4. The intelligent care training system according to claim 1, wherein the sensing module further comprises a pressure sensor disposed on the back of the mannequin body, configured to detect a tapping position, force and pressure distribution, count, time, or palm shape characteristics when the care operation comprises a back-patting operation.

5. The intelligent care training system according to claim 4, wherein the processing unit determines, based on the sensing data generated by the pressure sensor, whether the back-patting operation satisfies the predetermined operation condition.

6. The intelligent care training system according to claim 1, wherein the at least one second sensor comprises an inertial measurement unit and/or a bending sensing element disposed on at least part of the plurality of limbs, and the processing unit determines the motion states of the at least part of the plurality of limbs based on angle information detected by the inertial measurement unit and/or a bending degree detected by the bending sensing element.

7. The intelligent care training system according to claim 1, wherein the sensing module further comprises an optical sensor disposed on the mannequin body, configured to detect a covering state of clothing on the mannequin body; and the processing unit determines, based on the sensing data generated by the optical sensor, whether a dressing/undressing operation satisfies a predetermined dressing/undressing condition.

8. The intelligent care training system according to claim 7, wherein when the dressing/undressing operation is directed to a care recipient having an affected side and an unaffected side, the processing unit determines, based on a covering position and a covering sequence of the clothing on the mannequin body, whether the dressing/undressing operation satisfies a condition of a dressing/undressing sequence.

9. The intelligent care training system according to claim 1, wherein the processing unit has an online mode and a standalone mode, to execute a training process via an external operation interface in the online mode, and to execute sensing data determination and feedback output from inside the mannequin body in the standalone mode.

10. The intelligent care training system according to claim 1, further comprising:
a training data recording module configured to record an operation result of the care operation; and/or
a display unit configured to display guidance information or evaluation information corresponding to the care operation.

11. An intelligent care training method, comprising:
detecting, by a first sensor disposed on a mannequin body, a posture change of a trunk, and detecting, by at least one second sensor disposed on at least part of a plurality of limbs, motion states of the at least part of the plurality of limbs, wherein the first sensor and the second sensor are configured to generate sensing data when a user performs a care operation on the mannequin body;
receiving, by a processing unit, the sensing data, and determining, based on the sensing data, an operation state of the care operation;
comparing, by the processing unit, the sensing data with at least one predetermined operation condition, to determine whether the care operation satisfies an expected training requirement; and
outputting, by a feedback module, a feedback signal based on the operation state;
wherein when the care operation comprises a turning-over operation, the processing unit determines, based on the posture change of the trunk and the motion states of the at least part of the plurality of limbs detected by the second sensors, whether at least one of a hand-lifting state, a foot-lifting state, and a turning-over state of the turning-over operation satisfies the at least one predetermined operation condition.

12. The intelligent care training method according to claim 11, wherein the at least one counterweight module is disposed respectively inside at least part of the trunk and the plurality of limbs, to form a configuration of trunk counterweight and limb counterweight.

13. The intelligent care training method according to claim 12, wherein the at least one counterweight module is adjustable in counterweight size and counterweight distribution, to simulate a body type, a human body center of gravity distribution, physical conditions, or physical state of different care recipients.

14. The intelligent care training method according to claim 11, wherein the sensing module further comprises a pressure sensor disposed on a back of the mannequin body, configured to detect a tapping position, force and pressure distribution, count, time, or palm shape characteristics through a pressure sensor disposed on a back of the mannequin body when the care operation comprises a back-patting operation.

15. The intelligent care training method according to claim 14, wherein the processing unit determines, based on the sensing data generated by the pressure sensor, whether the back-patting operation satisfies the predetermined operation condition.

16. The intelligent care training method according to claim 11, wherein the at least one second sensor comprises an inertial measurement unit and/or a bending sensing element disposed on at least part of the plurality of limbs, and the processing unit determines the motion states of the at least part of the plurality of limbs based on the angle information detected by the inertial measurement unit and/or the bending degree detected by the bending sensing element.

17. The intelligent care training method according to claim 11, wherein when the care operation comprises a dressing/undressing operation, the method further comprises:
detecting, by an optical sensor disposed on the mannequin body, a covering state of clothing on the mannequin body; and
determining, by the processing unit, based on the sensing data generated by the optical sensor, whether the dressing/undressing operation satisfies a predetermined dressing/undressing condition.

18. The intelligent care training method according to claim 16, wherein when the dressing/undressing operation is directed to a care recipient having an affected side and an unaffected side, the processing unit determines, based on the covering position and the covering sequence of the clothing on the mannequin body, whether the dressing/undressing operation satisfies the condition of a dressing/undressing sequence.

19. The intelligent care training method according to claim 11, further comprising:
in an online mode, executing a training process via an external operation interface; and
in a standalone mode, performing sensing data determination and feedback output by the processing unit disposed inside the mannequin body.

20. The intelligent care training method according to claim 11, further comprising:
recording the operation result of the care operation; and/or
displaying guidance information or evaluation information corresponding to the care operation.
